(19) United States
(12) Patent Application Publication
(10) Pub. No.: US 2017/0153733 A1
(43) Pub. Date: Jun. 1, 2017

(54) TOUCH DISPLAY PANEL AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Yanchen LI, Beijing (CN); Peizhi CAI, Beijing (CN); Hailin XUE, Beijing (CN); Guangquan WANG, Beijing (CN)

(21) Appl. No.: 15/306,896

(22) PCT Filed: Mar. 25, 2016
(86) PCT No.: PCT/CN2016/077332

§ 371 Date: Oct. 26, 2016

(30) Foreign Application Priority Data
May 22, 2015 (CN) 201510266757.X

(51) Int. Cl. G06F 3/041; G06F 3/044

(52) U.S. Cl. CPC G06F 3/0412; G06F 3/044; G06F 2203/04103

(57) ABSTRACT

The disclosure provides a touch display panel including an array substrate and a laminated color filter substrate. A predetermined surface of the first peripheral region includes an external pin thereon. The array substrate and the laminated color filter laminated include a first peripheral region extending beyond an edge of the array substrate. The external pin is connected with a touch control circuit.

### CROSS-REFERENCES TO RELATED APPLICATIONS

This application is a National Stage entry of PCT/CN2016/077332 filed Mar. 25, 2016, which claims the benefit and priority of Chinese Patent Application No. 201510266757.X, filed on May 22, 2015, both of which are incorporated herein by reference in their entirety.

### BACKGROUND

The present disclosure relates to the field of display technology, and particularly, to a touch display panel and a display device.

In order to achieve a thin and lightweight touch display panel, the research integrating a touch display panel with a liquid crystal panel is increasingly popular. Currently, in order to realize the integration of a touch display panel and a liquid crystal panel, the touch function of the touch display panel is usually realized by the methods of “On-Cell” and “In-Cell”. On-Cell refers to embedding a touch function component of the touch display panel onto a color filter substrate of the touch display panel, while In-Cell refers to embedding the touch function component of the touch display panel between an array substrate and a color filter substrate of the touch display panel.

When using On-Cell and In-Cell, in order to solder a driver chip (IC) and a main flexible circuit board, at the edge of the array substrate in the bottom of the touch display panel including a step edge that is 3 mm or more beyond the edge of the color filter substrate, the color filter substrate in the corresponding position will be cut off, reducing the utilization of the color filter substrate.

### BRIEF DESCRIPTION

Embodiments of the present disclosure provide a touch display panel and a display device that implement the compatibility of a touch display panel including an On-Cell or In-Cell touch function with a touch display panel not including an On-Cell or In-Cell touch function, while improving the utilization of a color filter substrate.

According to a first aspect of the present disclosure, there is provided a touch display panel including an array substrate and a color filter substrate laminated, the color filter substrate including a first peripheral region extending beyond an edge of the array substrate, a predetermined surface of the first peripheral region including an external pin, the external pin being connected with a touch control circuit.

In an embodiment of the disclosure, the array substrate includes a second peripheral region extending beyond the edge of the color filter substrate at the other side opposite to the side where the first peripheral region is located, and includes a display driver chip on the surface of the second peripheral region adjacent to the color filter substrate.

In an embodiment of the disclosure, the length of the first peripheral region that extends beyond the edge of the array substrate ranges from 0.8 mm to 1.5 mm.

In an embodiment of the present disclosure, the predetermined surface is a surface of the first peripheral region remote from the array substrate, and the surface of the color filter substrate remote from the array substrate includes thereon a touch film layer configured to realize a touch function.

In an embodiment of the present disclosure, the external pin is electrically connected to touch wiring of a touch film layer.

In an embodiment of the present disclosure, a polarizing sheet is further provided on the touch film layer.

In an embodiment of the present disclosure, the predetermined surface is a surface of the first peripheral region adjacent to the array substrate, and a surface of the color filter substrate adjacent to the array substrate includes a first touch electrode film layer thereon.

In an embodiment of the present disclosure, the external pin is electrically connected to electrode wiring of the first touch electrode film layer.

In an embodiment of the present disclosure, the array substrate includes a second touch electrode film layer, wherein electrodes of the first touch electrode film layer and electrodes of the second touch electrode film layer are crossed.

According to a second aspect of the present disclosure, there is also provided a display device including a touch display panel as described above.

For the touch display panel and the display device provided in the embodiment of the present disclosure, a portion of the color filter substrate is cut off at a corresponding position of the array substrate beyond the peripheral region of the color filter substrate, and the peripheral region of the color filter substrate extending beyond the array substrate is retained, and the external pin is provided thereon to connect the touch control circuit (arranged in the touch flexible circuit) to realize the On-Cell or In-Cell touch function, improving the utilization of the color filter substrate.

### BRIEF DESCRIPTION OF THE DRAWINGS

In order to more clearly illustrate the technical solution of embodiments of the present disclosure, the drawings of the embodiments will be briefly described below. It should be understood that the drawings described below merely relate to some embodiments of the present disclosure but are not intended to limit the present disclosure, in which

FIG. 1 is a schematic structural view of an On-Cell touch display panel in the prior art;

FIG. 2 is a schematic structural view of an On-Cell touch display panel according to a first embodiment of the present disclosure;

FIG. 3 is a schematic plan view of an array substrate in the On-Cell touch display panel shown in FIG. 2;

FIG. 4 is a schematic plan view of a color filter substrate in the On-Cell touch display panel shown in FIG. 2;

FIG. 5 is a schematic plan view of the On-Cell touch display panel shown in FIG. 2;

FIG. 6 is a schematic structural view of an In-Cell touch display panel in the prior art;

FIG. 7 is a schematic structural view of an In-Cell touch display panel according to a second embodiment of the present disclosure;

FIG. 8 is a schematic view of wiring of traverse electrodes in the array substrate in the In-Cell touch display panel shown in FIG. 7;

FIG. 9 is a schematic view of wiring of longitudinal electrodes in the color filter substrate in the In-Cell touch display panel shown in FIG. 7;

FIG. 10 is a schematic view of wiring of traverse and longitudinal electrodes in the In-Cell touch display panel shown in FIG. 7;

### DETAILED DESCRIPTION

Hereinafter, embodiments of the present disclosure will be described in further detail with reference to the accompanying drawings. The following embodiments are only intended to more clearly illustrate the technical solution of the present disclosure and are not intended to limit the scope of the disclosure.

The specific structures of the On-Cell touch display panel and the In-Cell touch display panel will be described below in detail with reference to the specific embodiments.

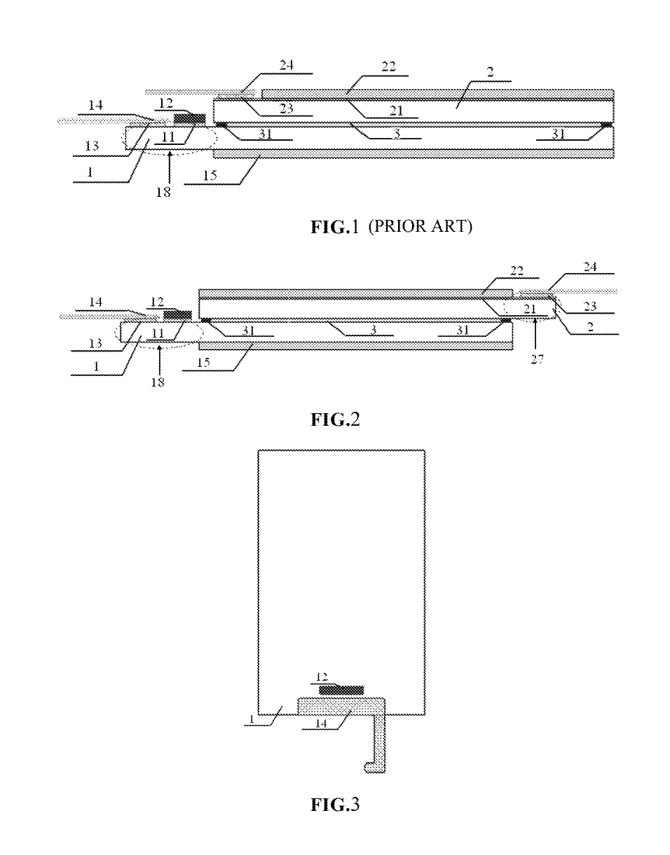

FIG. 1 is a schematic structural view of an On-Cell touch display panel in the prior art. As shown in FIG. 1, in order to solder a display driver chip 12 and a main flexible circuit board 14 on an upper surface of a second peripheral region 18 (i.e., the surface of an array substrate 1 toward a color filter substrate 2), the color filter substrate 2 in the corresponding position needs to be cut off. In addition, it is necessary to ensure a sufficient distance between the edge of the color filter substrate 2 on the soldered side and an valid display region when directly soldering a touch flexible circuit board 24 on the color filter substrate 2, and the distance is generally 2-2.5 mm, and in order to monitor the soldering state of the touch flexible circuit board 24, the array substrate 1 and the color filter substrate 2 at the positions corresponding to the soldering region need to be light-transmissive and can not form any pattern, so that after the On-Cell touch function is added, the distance between the edge of the array substrate 1 to the valid display region is greatly increased. Without changing the existing product design, the direct increase in On-Cell touch function is difficult to meet the above requirements.

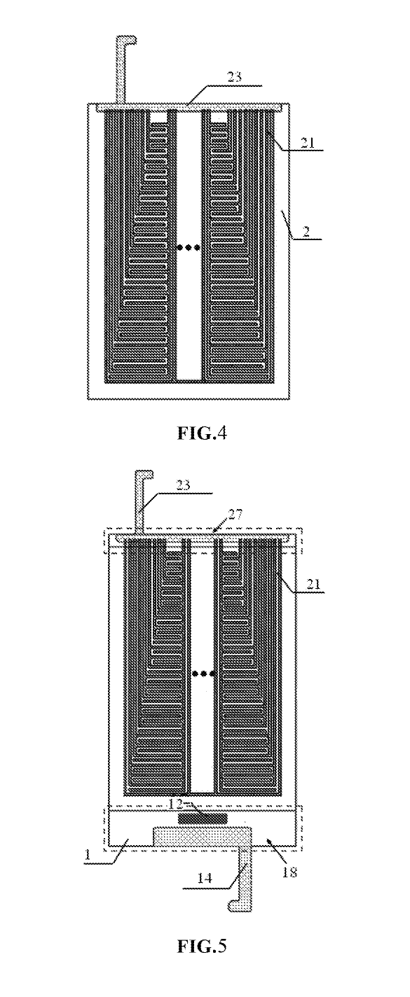

FIG. 2 is a schematic structural view of an On-Cell touch display panel according to a first embodiment of the present disclosure. FIG. 3 is a schematic plan view of an array substrate in the On-Cell touch display panel shown in FIG. 2. FIG. 4 is a schematic plan view of a color filter substrate in the On-Cell touch display panel shown in FIG. 2.

As shown in FIG. 2, an embodiment of the present disclosure provides a touch display panel including an array substrate 1 and a color filter substrate 2 which are laminated by a celling process, wherein the color filter substrate 2 includes, on one side, a first peripheral region 27 which extends beyond the edge of the array substrate 1, on the predetermined surface of which first peripheral region 27 there is provided an external pin bound with the touch flexible circuit board 24, so that the external pin is connected to the touch control circuit. Due to the widespread adoption of the flexible circuit board technology, in the touch display panel, the touch control circuit and the like may be provided in the flexible circuit board so as to achieve a small, thin, and flexible equipment.

It may be understood that the predetermined surface of the above-described first peripheral region 27 can be understood as an upper surface or a lower surface of the color filter substrate 2 of the first peripheral region 27, where the surface of the color filter substrate 2 remote from the array substrate 1 is the upper surface, and the surface of the color filter substrate 2 close to the array substrate 1 is the lower surface. When an external pin is provided on the upper surface of the color filter substrate 2 and the touch flexible circuit board 24 is bonded to the external pin, for the touch display panel suitable for On-Cell touch function, the On-Cell touch function component is embedded between the color filter substrate 2 and the upper polarizing sheet 22. When an external pin is provided on the bottom surface of the color filter substrate 2 and the touch flexible circuit board 24 is bonded to the external pin, for the touch display panel suitable for In-Cell touch function, the In-Cell touch function component is embedded between the array substrate 1 and the color filter substrate 1.

In the touch display panel, a portion of the color filter substrate 2 is cut off at the corresponding position of the array substrate 1 beyond the peripheral region of the color filter substrate 2, the peripheral region of the color filter substrate 2 beyond the array substrate 1 is retained, and the external pin and the touch flexible circuit board 24 are provided on the peripheral region of the color filter substrate 2 beyond the array substrate 1, in order to implement the On-Cell or In-Cell touch function, therein improving the utilization ratio of the color filter substrate 2.

The touch display panel abovementioned is located on the other side opposite to the side where the first peripheral region 27 is located, the array substrate 1 includes a second peripheral region 18 which extends beyond the edge of the color filter substrate 2, and on the upper surface of the second peripheral region 18 adjacent to the color filter substrate 2, there is provided a display driver chip 12. Here, the surface of the array substrate 1 close to the color filter substrate 2 is the upper surface, and the surface of the array substrate 1 remote from the color filter substrate 2 is the lower surface.

In order to ensure that the space between the edge of the color filter substrate 2 of the first peripheral region 27 and the valid display region of the touch display panel is 2-2.5 mm, to solder the touch flexible circuit board, the length of the first peripheral region 27 beyond the array substrate 1 is set to in a range from 0.8 mm to 1.5 mm, preferably to 1 mm. As shown in FIG. 2, in the embodiment of the present disclosure, with the color filter substrate 2 provided in the first peripheral region 27, the material of the color filter substrate 2 cut off in the corresponding position of the second peripheral region 18 is effectively used, without changing the specification of the color filter substrate 2 in order to add the On-Cell touch function, thereby improving the utilization of the color filter substrate 2. There is no pattern on the lower surface of the color filter substrate 2 (toward the array substrate surface), so that the color filter substrate 2 of the first peripheral region 27 is light-transmissive, without changing the design of the array substrate 1 and the color filter substrate 2 of an existing product, and meets the light-transmitting conditions for monitoring the soldering state of the touch flexible circuit board 24.

As shown in FIGS. 2 and 3, the array substrate 1 includes an array of pixels (not shown) for controlling liquid crystal deflection, provided on the upper surface of the array substrate 1 (i.e., the surface facing the color filter substrate 2), a first anisotropic conductive adhesive 11, provided on the array substrate 1, a display driver chip 12, soldered to the upper surface of the array substrate 1 via the first anisotropic conductive adhesive 11, a main flexible circuit board 14, soldered to the upper surface of the array substrate 1 through a second anisotropic conductive adhesive 13, and a lower polarizing sheet 15, provided on the lower surface of the array substrate 1 and missing at the second peripheral region 18.

As shown in FIGS. 2 and 4, the color filter substrate 2 includes a color filter pixel array (not shown) for controlling color, provided on a lower surface of the color filter substrate 2 (i.e., the surface toward the array substrate 1), a transparent conductive layer 21, provided on the upper surface of the color filter substrate 2, a touch film layer, formed on the transparent conductive layer 21 by a mask process, having an On-Cell touch function, an external pin for soldering the touch flexible circuit board 24, the external pin being provided on a predetermined surface of the first peripheral region 27 which is the upper surface of the first peripheral region 27 away from of the array substrate 1. With respect to the touch film layer for implementing a touch function provided on the upper surface of the color filter substrate 2 (not shown), it is to be understood that the above-mentioned external pin is provided on the first peripheral region 27, the touch film layer is provided in the non-first peripheral region 27, and the touch wiring of the touch film layer is electrically connected to the external pin, and the touch flexible circuit board 24 is bound to the external pin. An upper polarizing sheet 22, provided on the transparent conductive layer 21, that is, on the touch film layer, and missing in the first peripheral region 27.

FIG. 5 is a schematic plan view of the On-Cell touch display panel shown in FIG. 2. The plan views of the array substrate and the color filter substrate are shown in FIG. 5, and the present embodiment does not describe in detail the specific shape structures of the transparent conductive layer 21, the touch film layer, the external pin, the main flexible circuit board 14, and the touch flexible circuit board 24. FIG. 5 is for illustration only, but does not limit the structure of each of the respective film layers.

The liquid crystal layer 3 includes a liquid crystal (not shown), an PI orientation layer disposed on the upper and lower surfaces of the liquid crystal, and a sealant 31 provided between the array substrate 1 and the color filter substrate 2 for bonding the array substrate 1 and the color filter substrate 2, and sealing the liquid crystal layer.

In order to ensure that the space between the first peripheral region 27 and the valid display region is 2-2.5 mm to fit the upper polarizing sheet 22 and solder the touch flexible circuit board 24, the range of length of the color filter substrate 2 of the first peripheral region 27 beyond the array substrate 1 is set from 0.8 mm to 1.5 mm, preferably 1 mm. Further, the length of the array substrate 1 of the second peripheral region 18 on the opposite side of the side where the first peripheral region 27 is located beyond the edge of the color filter substrate 2 is set to a range from 3 mm or more to ensure that there is sufficient space for soldering the display driver chip 12 and the main flexible circuit board 14.

The present embodiment realizes the On-Cell touch function by designing the first peripheral region 27 only by setting the parameters of the cutter at the time of cutting to form a first peripheral region 27 of a desired size and determining the length of the edge of the color filter substrate 2 that extends beyond the edge of the array substrate 1, without the need to change the existing product design, to have good compatibility with existing non-On-Cell products. For the same product, if the On-Cell touch function is not required, the On-Cell-related process may not be carried out and at the first peripheral region 27 of the color filter substrate 2 is not retained at the time of cutting and at the first peripheral region 27 of the color filter substrate 2 is not retained at the time of cutting. If the On-Cell touch function is required, the On-Cell-related process may be carried out and the color filter substrate 2 at the first peripheral region 27 is retained at the time of cutting. In addition, this approach can also be compatible with the current mainstream G/F/F (Glass-Film-Film) touch solution well.

The scheme of the embodiments abovementioned applied to the In-Cell touch display panel will be described below in detail.

The In-Cell touch display panel is divided into self-capacitance and mutual-capacitance modes. The self-capacitance mode means that a transverse electrode (TX) and a longitudinal electrode (RX), respectively, form capacitances with the common electrode, while the mutual-capacitance mode means that a transverse electrode and a longitudinal electrode form a capacitance at the place of mutual cross thereof. When detecting the magnitude of mutual-capacitance, the transverse electrodes sequentially emit an excitation signal and the longitudinal electrodes simultaneously receive the signal to obtain a distribution of capacitance values of the entire two-dimensional plane of the touch display panel so as to calculate the coordinates of each touch point according to the variation of the capacitance.

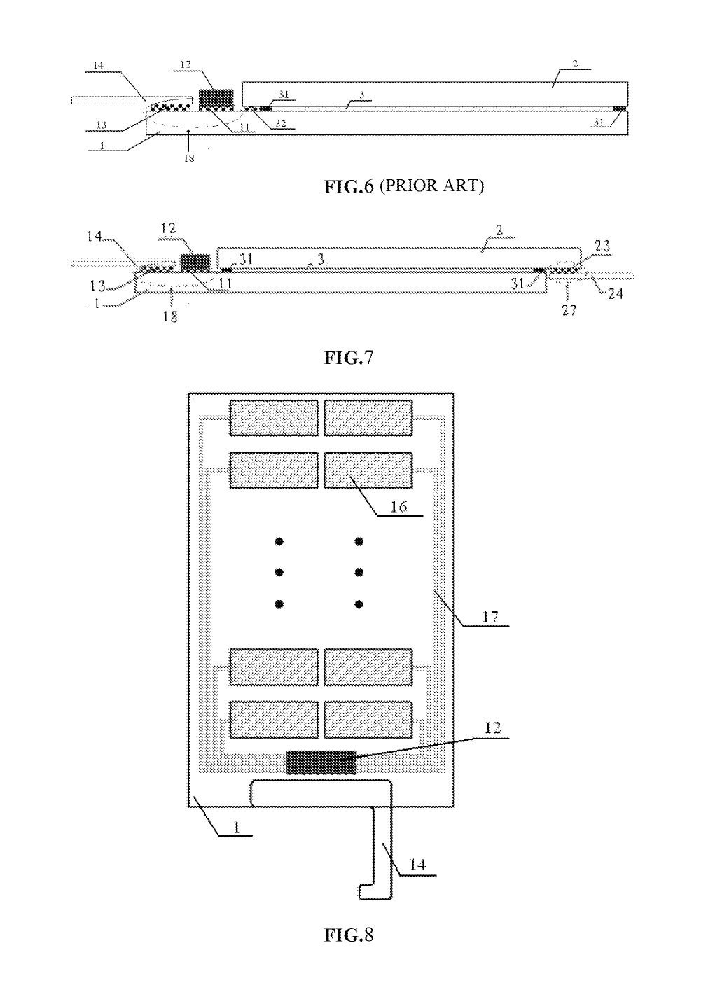

FIG. 6 is a schematic structural view of an In-Cell touch display panel in the prior art. In order to realize the touch function of the In-Cell mutual-capacitance mode, as shown in FIG. 6, the prior art requires providing the transverse electrode wiring for emitting the excitation signal and the longitudinal electrode wiring for receiving the excitation signal on the array substrate 1 and the color filter substrate 2, respectively, connecting the longitudinal electrode wiring located on the color filter substrate 2 to the array substrate 1 by separately disposing a strip of conductive adhesive of anisotropic conducting property between the array substrate 1 and the color filter substrate 2, and implementing the driving and detection of the capacitance signal of the longitudinal electrodes through the display driver chip 12 or the flexible circuit board soldered on the array substrate 1. In the embodiment of the present disclosure, a fourth anisotropic conductive adhesive 32 is provided between the array substrate 1 and the color filter substrate 2 for turning on an RX connection line (not shown) on the array substrate 1 and RX wiring (not shown) on the color filter substrate 2. The RX wiring on the color filter substrate 1 is connected electrically to the main flexible circuit 14 by the fourth anisotropic conductive adhesive 32, RX connecting line and the second anisotropic conductive adhesive 13. The approach of using the method abovementioned to connect the RX electrode wiring located on the color filter substrate 2 to the array substrate 1 by arranging the anisotropic conductive adhesive to implement the driving will be affected by various factors like tight wiring space on the array substrate 1, the fluctuations in the thickness of the liquid crystal cell between the array substrate 1 and the color filter substrate 2, uneven conductive adhesive coating, the size and density of the conductive particle in the conductive adhesive, leading to a large drive resistance of the longitudinal electrodes so that they may not be turned on normally. On the other hand, in order to solder the display driver chip 12 or the flexible circuit board on the array substrate 1, it is required to dispose the second peripheral region 18 of the array substrate 1 beyond the edge of the color filter substrate 2 and cut off the color filter substrate 2 at the corresponding position. Therefore, the above-mentioned scheme not only raises the complexity of the manufacturing process of the touch display panel, affects the yield of the product, but also reduces the utilization ratio of the color filter substrate 2.

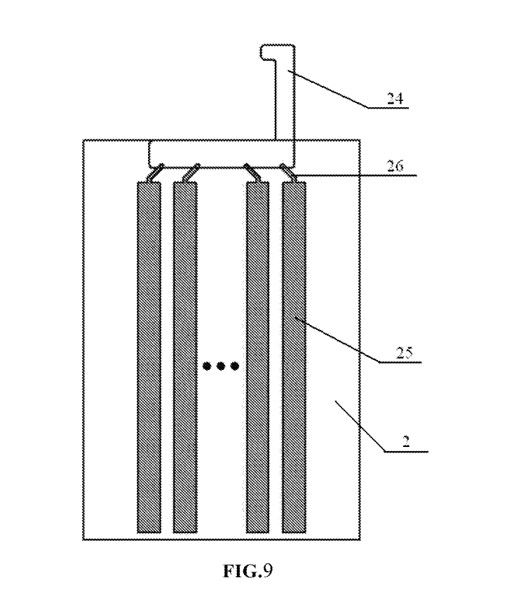

FIG. 7 is a schematic structural view of an In-Cell touch display panel according to a second embodiment of the present disclosure. FIG. 8 is a schematic view of wiring of traverse electrodes in the array substrate in the In-Cell touch display panel shown in FIG. 7. FIG. 9 is a schematic view of wiring of longitudinal electrodes in the color filter substrate of the In-Cell touch display panel shown in FIG. 7. In the present embodiment, with the color filter substrate 2 provided in the first peripheral region 27, the portion of the color filter substrate 2 in the corresponding position of the second peripheral region 18 which is cut off is effectively utilized, without the need to change the specification of the color filter substrate 2, improving the utilization of the color filter substrate 2. Moreover, the touch flexible circuit board 24 for driving the longitudinal electrode wiring is provided on the lower surface (the surface toward the array substrate) of the color filter substrate 2 of the first peripheral region 27, and this solution does not be affected by various factors like the fluctuation in the thickness of the liquid crystal cell between the array substrate 1 and the color filter substrate 2, uneven conductive adhesive coating, the size and density of the conductive particle in the conductive adhesive and the like, preventing a large drive resistance of the longitudinal electrode wiring and the phenomena of being not turned on normally. Thus, under the premise of ensuring the connectivity of the longitudinal RX wiring 25, the scheme of the present embodiment reduces the resistance of the RX wiring 25 and improves the ability of driving and detecting of the RX wiring 25, thereby reducing the process complexity of the In-Cell mutual-capacitance touch display panel, improving the yield of the product, and improving the utilization of the color filter substrate 2.

As shown in FIG. 7, the array substrate 1 includes an array of pixels (not shown) for controlling the liquid crystal deflection, provided on the upper surface of the array substrate 1 (i.e., the surface toward the color filter substrate 2), a first anisotropic conductive adhesive 11, provided on the array substrate 1, a display driver chip 12, soldered to the array substrate 1 through the first anisotropic conductive adhesive 11 and electrically connected to the TX connection line 17 on the array substrate 1, a second anisotropic conductive adhesive 13, soldered on the array substrate 1, a main flexible circuit board 14, soldered to the array substrate 1 through the second anisotropic conductive adhesive 13 and forming an electrical connection with associated wiring on the array substrate 1, TX wiring 16, provided on the array substrate 1, and a TX connection line 17, provided on the array substrate 1. As shown in FIG. 8, the TX wiring 16 and the display driver chip 12 are electrically connected via the first anisotropic conductive adhesive 11 and the TX connection line 17. In the specific structure, a lower polarizing sheet 15 (not shown in FIG. 7, specifically, see FIG. 2) is further provided on the lower surface of the array substrate 1 and is missing at the second peripheral region 18.

The color filter substrate 2 includes a color filter pixel array (not shown in FIG. 7) for controlling color, provided on the lower surface of the color filter substrate 2 (i.e., the surface toward the array substrate 1), a third anisotropic conductive adhesive 23, arranged on the color filter substrate 2, a first touch electrode film layer comprising RX wiring 25 provided on the lower surface of the color filter substrate 2 close to the array substrate 1, a touch flexible circuit board 24, soldered to the color filter substrate 2 via the third anisotropic conductive adhesive 23, so that the external pin on the lower surface of the first peripheral region 27 of the color filter substrate 2 is electrically connected to the electrode wiring of the first touch electrode film layer, that is, the RX connection line 26 and the RX wiring 25 are electrically connected. As shown in FIG. 9, the RX wiring 25 is provided on the color filter substrate 2, and the RX connection line 26 is provided on the color filter substrate 2. The RX wiring 25 and the touch flexible circuit board 24 are electrically connected via the third anisotropic conductive adhesive 23 and the RX connection line 26.

The liquid crystal layer 3 includes liquid crystals (not shown), a sealant 31 provided between the array substrate 1 and the color filter substrate 2, for bonding the array substrate 1 and the color filter substrate 2, and achieving the tightness of the liquid crystal layer.

On the upper edge of the touch display substrate, the upper edge of the color filter substrate 2 extends beyond the array substrate 1 to form a first peripheral region 27. A third anisotropic conductive adhesive 23 is applied to the first peripheral region 27, a touch flexible circuit board 24 is soldered and a RX connection line 26 is arranged on the first peripheral region 27. On the lower edge of the touch display substrate, the lower edge of the array substrate 1 extends beyond the color filter substrate 2 to form a second peripheral region 18 on which the various necessary signal lines and patterns of the TFT array (not shown) are provided, the first anisotropic conductive adhesive 11 and the second anisotropic conductive adhesive 13 are coated, and the display driver chip 12 and the main flexible circuit board 14 and the TX connection line 17 are soldered. For example, when the mutual capacitance is detected, the display driver chip 12, as the driver circuit of the TX wiring 16, sequentially inputs an excitation signal to the TX wiring 16, and at the same time, all the RX wiring 25 simultaneously receive the signal, so as to detect the magnitude of capacitance of the intersection of all the TX wiring 16 and the RX wiring 25, the coordinates of each touch point can be calculated according to the amount of change in capacitance, therefore the touch function can be achieved.

For the touch display panel having the In-Cell touch function provided in the present embodiment, the touch flexible circuit board 24 for driving the RX wiring 25 is directly soldered on the color filter substrate 2. Since it is not needed to connect the RX wiring 25 from the color filter substrate 2 to the array substrate 1 via the conductive adhesive, and under the premise of being compatible with the conventional touch display panel manufacturing process, this can ensure the connectivity of the RX wiring 25, reduce the resistance of the RX wiring 25 and improve the ability of driving and detecting the RX wiring 25, as well as avoid the high process complexity and low production yield of the touch display panel due to the introduction of In-Cell mutual-capacitance touch function. In addition, the display driver chip 12 and the touch flexible circuit board 24 are provided at both ends of the array substrate 1 and the color filter substrate 2 after celling, respectively, without producing a new standard color filter substrate or cutting off too much of the color filter substrate, therefore the utilization of the color filter substrate 2 is improved.

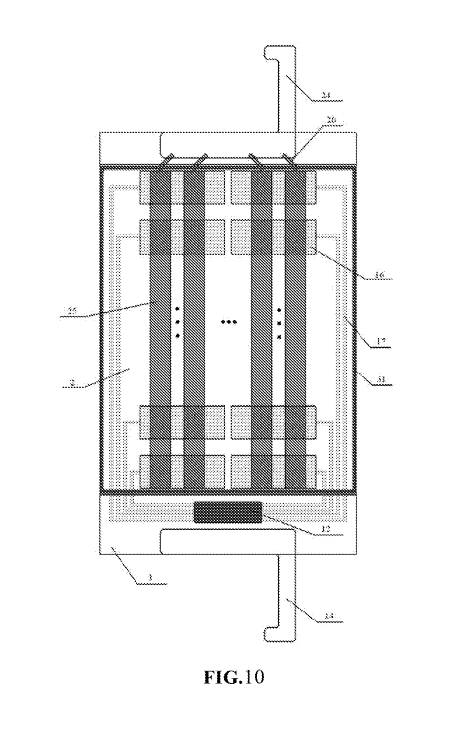

FIG. 10 is a schematic view of wiring of traverse and longitudinal electrodes in the In-Cell touch display panel shown in FIG. 7. The plan views of the array substrate 1 and the color filter substrate 2 are as shown in FIG. 10, the TX wiring 16 of the second touch electrode film layer on the upper surface of the array substrate 1 and the RX wiring of the first touch electrode film layer on the color filter substrate 2 are crossed in an arrangement. The specific shape structures of the RX wiring 25, the RX connection line 26, the TX wiring 16, the TX connection line 17, the main flexible circuit board 14, and the touch flexible circuit board 24 in this embodiment will not be described in detail. FIG. 10 is for illustration only and does not limit the structure of the wiring in the plan views of the touch display panel.

Embodiments of the present disclosure also provide a display device including a touch display panel as described above.

The display device in the embodiment of the present disclosure may be a mobile phone, a tablet computer, a television set, a notebook computer, a digital photo frame, a navigator, or any product or component having a display function.

In the description of the present disclosure, numerous specific details are set forth. It will be understood, however, that embodiments of the disclosure may be practiced without these specific details. In some instances, well-known methods, structures, and techniques have not been shown in detail in order not to obscure the understanding of this specification.

Finally, it should be noted that the above embodiments are merely illustrative of the technical solutions of the present disclosure and are not to be construed as limitations thereof. While the disclosure has been described in detail with reference to the foregoing embodiments, it will be understood by those skilled in the art that the technical solutions described in the foregoing embodiments may still be modified or equivalently replaced with some or all of the technical features, and these modifications or substitutions do not cause the essence of the corresponding technical solutions to depart from the scope of the technical solutions of respective embodiments of the present disclosure, and should be encompassed within the scope of the claims and the description of the present disclosure.

What is claimed is:

1. A touch display panel, comprising:
an array substrate and a laminated color filter substrate, wherein the color filter substrate includes a first peripheral region extending beyond an edge of the array substrate, and wherein a predetermined surface of the first peripheral region includes an external pin thereon, the external pin connected with a touch control circuit.

2. The touch display panel according to claim 1, wherein the array substrate includes a second peripheral region extending beyond the edge of the color filter substrate at the other side opposite to the side where the first peripheral region is located, and wherein the array substrate includes a display driver chip on a surface of the second peripheral region adjacent to the color filter substrate.

3. The touch display panel according to claim 1, wherein the length of the first peripheral region that extends beyond the edge of the array substrate ranges from 0.8 mm to 1.5 mm.

4. The touch display panel according to claim 1, wherein the predetermined surface is a surface of the first peripheral region remote from the array substrate, and wherein the surface of the color filter substrate remote from the array substrate includes thereon a touch film layer configured to realize a touch function.

5. The touch display panel according to claim 4, wherein the external pin is electrically connected to touch wiring of the touch film layer.

6. The touch display panel according to claim 4, wherein a polarizing sheet is further provided on the touch film layer.

7. The touch display panel according to claim 1, wherein the predetermined surface is a surface of the first peripheral region close to the array substrate, and wherein a surface of the color filter substrate close to the array substrate includes a first touch electrode film layer thereon.

8. The touch display panel according to claim 7, wherein the external pin is electrically connected to electrode wiring of the first touch electrode film layer.

9. The touch display panel according to claim 7, wherein the array substrate includes a second touch electrode film layer thereon, and wherein the electrodes of the first touch electrode film layer and wherein the electrodes of the second touch electrode film layer are crossed.

10. A display device comprising a touch display panel according to claim 1.

11. The touch display panel according to claim 2, wherein the predetermined surface is a surface of the first peripheral region remote from the array substrate, and wherein the surface of the color filter substrate remote from the array substrate includes thereon a touch film layer configured to realize a touch function.

12. The touch display panel according to claim 3, wherein the predetermined surface is a surface of the first peripheral region remote from the array substrate, and wherein the surface of the color filter substrate remote from the array substrate includes thereon a touch film layer configured to realize a touch function.

13. The touch display panel according to claim 2, wherein the predetermined surface is a surface of the first peripheral region close to the array substrate, and wherein a surface of the color filter substrate close to the array substrate includes a first touch electrode film layer thereon.

14. The touch display panel according to claim 3, wherein the predetermined surface is a surface of the first peripheral region close to the array substrate, and wherein a surface of the color filter substrate close to the array substrate includes a first touch electrode film layer thereon.

15. A display device comprising a touch display panel according to claim 2.

16. A display device comprising a touch display panel according to claim 3.

17. A display device comprising a touch display panel according to claim 4.

18. A display device comprising a touch display panel according to claim 5.

19. A display device comprising a touch display panel according to claim 6.

20. A display device comprising a touch display panel according to claim 7.
